(19) United States
(12) Patent Application Publication
(10) Pub. No.: US 2006/0004804 A1
(43) Pub. Date: Jan. 5, 2006

(54) System and method for timely updating specific fields of a web page

(76) Inventor: Cheng-Hsing Liao, Pingjhen City (TW)

Correspondence Address: HARNESS, DICKEY & PIERCE, P.L.C., P.O. BOX 8910, RESTON, VA, 20195, US

(21) Appl. No.: 10/852,114

(22) Filed: May 25, 2004

(51) Int. Cl. G06F 17/00

(52) U.S. Cl. 707/101

(57) ABSTRACT

In a system and method of timely updating specific fields of a web page, an updating program installed at the client timely downloads via a network update data stored at a server, and writes the update data in a specific field of the web page displayed in the browser of the client.

### BACKGROUND OF THE INVENTION

1. Field of Invention

The present invention relates to a data updating system and method. More particularly, the invention provides a system and method for timely updating specific fields of a web page.

2. Related Art

The update of web page contents can be conducted according to several techniques. In one technique known in the art, the web page update is activated at the client and the system automatically connects via the network to the server to download the home page or a preset link web page. To this end, the client usually needs to perform again the same steps previously performed to register into the web page, so as to download update data of the web page. For example, some Internet email service providers require the user to perform again the registering process to obtain new email updates of the email box.

In another technique known in the art, the server creates a new web page frame to display the updated web page after the client triggers the update operation. The technique may be disadvantageous because successive updates will lead to the creation of many new frames to obtain update data, which will waste the system resource and occupy a substantial use of the network bandwidth.

In addition, downloading web page contents usually undergoes a complex sequence of communication and data transmission steps. In the update technique of the prior art where a new web page is to be downloaded every time an update is required, repeating this proceeding sequence may lead to a wrong web page or even a failure, and the user thus cannot continue a normal operation.

On the other hand, when the client performs an update operation, the downloaded data include all the web page content encompassing texts, graphics, animated images, sounds, etc. Usually, not all the data downloaded during the update operation are the update information desired by the user. As a result, the systematic download of the whole web page content may occupy a substantial use of the network bandwidth and even cause transmission delays through the network. A transmission delay can cause undesired effects such as flickering of the web page display frame, impossibility for the system to perform other tasks, system crashes, etc. Further, when many clients simultaneously access to the data of the server, a resulting overload may cause a crash of the server.

Conventionally, if a user wants to obtain update data with respect to a specific field of the web page being displayed, he/she has to repeatedly perform the manual update operation. For example, a web page displayed at the client may be provided by a network auction system. The user thus generally needs update data corresponding to the specific fields of the “highest purchase price” for the auctioned article. To obtain the update data, the user conventionally has to manually perform web page updating, which usually includes the download of data contents other than the field of highest purchase price such as the seller information, the auctioned article data and picture, etc. Most of this other information is static data that are unchanged in time. The repeated download of these static data at every update operation is cumbersome and time-consuming, and further may cause undesired disadvantages such as system crashes, network delays, wastes of system resources, etc.

Therefore, there is a need for a system and method that can timely update specific fields of the web page and thereby overcome the disadvantages of the prior art techniques.

### SUMMARY OF THE INVENTION

It is therefore an objective of the invention to provide a system and method of timely updating specific fields of a web page which can overcome the prior disadvantages. The system and method can use the updating environment at the client to automatically and timely provide update data of specific fields of the web page, so that the update operation can be faster and more efficient.

To achieve the above and other objectives, a system of timely updating specific fields of a web page comprises a server and a client. The server stores a web page and update data, wherein the update data are established according to data changes provided by a plurality of user on a network. The client includes a browser program and an updating program. The browser program downloads and displays the web page, including data of specific fields of the web page. The updating program timely execution a procedure to download and writing update data in the specific fields of the web page.

According to an embodiment, the method of timely updating specific fields of a web page comprises: downloading and displaying a web page including a plurality of specific fields; timely updating one or more specific fields by downloading the update data; and writing the update data in the corresponding specific field and displaying the updated field.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given here in the illustration below only, and thus doesn't limit the present invention, wherein:

FIG. 1 is a block diagram of a system of timely updating specific fields of a web page according to an embodiment of the invention; and

FIG. 2 is a flowchart of a method of timely updating specific fields of a web page according to an embodiment of the invention.

### DETAILED DESCRIPTION OF THE INVENTION

In a system and method of timely updating specific fields of a web page according to the invention, an updating program installed at the client timely downloads via network update data stored at a server, and writes the update data in a specific field of the web page displayed in the browser of the client.

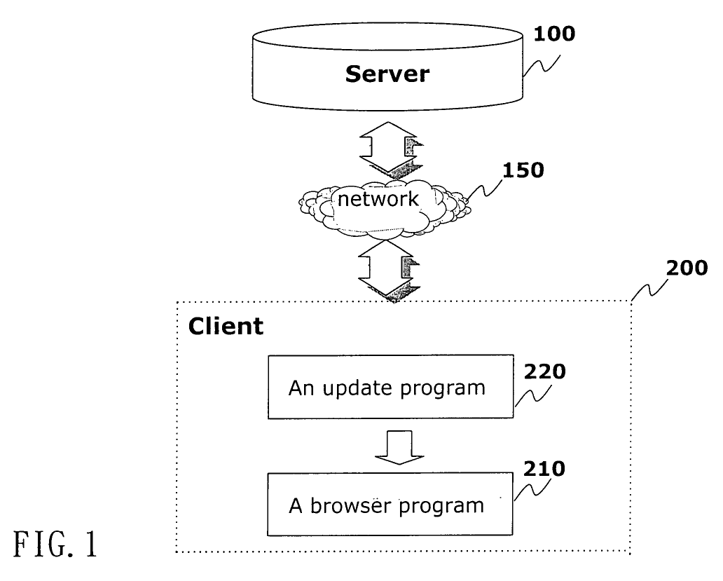

FIG. 1 is a block diagram of a system of timely updating specific fields of a web page according to an embodiment of the invention. The updating system comprises a server 100, and a client 200.

The server 100 stores web page data, including web page links, web page contents, update data, etc.

Update data are provided at the server 100 and are displayed on the web page at the client 200 to provide information to the user. The update data can be established from information feed-back from clients via the network 150 according to inquiries issued by the server 100. The server 100 can collect and analyze the feed-back information to obtain the update data to be displayed on the web page. The update data therefore are continuously modified according to the information flow received by the server 100 via the network.

In an example of a network auction system, the server 100 can provide clients 200 with the display of an article, to be purchased by auction. While clients 200 transmit to the server 100 their purchase price for the auctioned article, the server 100 collects all the purchase price information and timely determines the highest price to be displayed on a field of the web page at the client.

The server 100 can also deliver via the network 150 to the client 200 instantaneous update data such as news, information issued from financial systems, etc.

Update data as used herein thus mean a data content that can be timely subject to modification, and therefore the client 200 will need to continuously conduct web page updates.

The client 200 communicates with the server 100 via the network 150, to download web page and update data to be displayed in fields of the web page. The client 200 includes a browser program 210 and an updating program 220.

The browser program 210 downloads via the network 150 web page contents, including data of various web page fields stored in the server 100. While performing the download operation, the browser program 210 triggers the operation of the updating program 220. The browser program 210 includes a functionality of timely detecting whether the updating program 220 is still in execution. If it is detected that the updating program 220 no longer is executing or has been closed, the browser program 210 triggers once more the updating program 220, to determine whether specific fields of the web page being displayed in the browser program 210 include the latest update data.

After having been triggered by the browser program 210, the updating program 220 uses its timer to timely download from the server 100 via the network 150 update data that are then written in corresponding specific fields of the web page being displayed by the browser program 210.

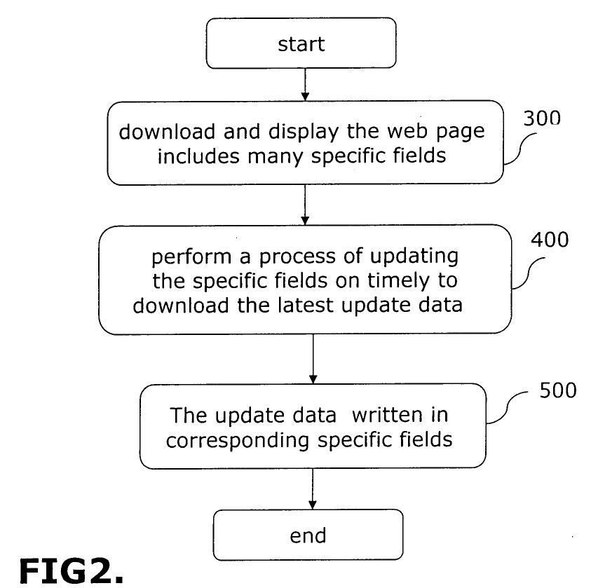

FIG. 2 is a flowchart of a method for timely updating a specific field of a web page according to an embodiment of the invention. First, a browser program 210 at the client 200 is operated to download and display the web page includes many specific fields from the server 100 via the network 150 (step 300). While downloading the foregoing data, the browser program 210 triggers the operation of an updating program 220 the updating program 220 include a timer to perform a process of updating the specific fields on timely update of the field data of the web page being displayed by the browser program 210, wherein the timely update operation includes downloading the latest update data from the server 100 via the network 150 (step 400). The update data then are written in corresponding specific fields of the web page being displayed by the browser program 210 at the client200 (step 500).

In an example of implementation of a network auction system, the browser program 210 can download via the network 150 and display a web page with its content provided by the network auction system located at the server 100. In this system, the client 200 needs to be timely updated with the purchase price proposed by other clients as well as the highest purchase price of the auction. To this end, the browser program 210 triggers the updating program 220 that accordingly timely downloads from the server 100 the update data of purchased price and highest purchased price from the server 100, and writes these update data in the corresponding specific fields of the web page displayed by the browser program 210.

With the system and method according to the invention, the update of specific fields of the displayed web page is performed by downloading only the data corresponding to these fields requiring updates downloading only the data corresponding to these fields requiring updates performs the update of specific fields of the displayed web page. In contrast to the prior art where the whole web page content is to be downloaded for specific field updates, the system and method of the invention therefore can avoid the transfer of a substantial amount of data for specific field updates. Further, the system and method of the invention can automatically perform timely field updates so that the client does not need to manually update the whole web page to obtain updated information.

It will be apparent to the person skilled in the art that the invention as described above may be varied in many ways, and notwithstanding remaining within the spirit and scope of the invention as defined in the following claims.

What is claimed is:

1. A system of timely updating specific fields of a web page, comprising:
a server, storing a web page and a plurality of update data, wherein the update data are established according to data changes provided by a plurality of user on a network or according to new data provided by the server to user; and
a client, communicating with the server, wherein the client displays the web page provided by the server and writes the update data in the web page, the client comprising:
a browser program, downloading and displaying the web page including a plurality of specific fields; and
an updating program, timely executing a procedure to download the update data and writing the update data in the specific fields of the web page.

2. The system of claim 1, wherein the browser program is a browser.

3. The system of claim 1, wherein the updating program includes a timer to timely updating data of the specific fields.

4. The system of claim 1, wherein the updating program downloads the update data via a network.

5. The system of claim 1, wherein the browser program timely verifies that the updating program is currently in execution.

6. A method of timely updating specific fields of a web page, downloading a plurality of update data from server to update a plurality of specific fields of client, comprising the steps of:
downloading and displaying a web page including the specific fields; timely executing a procedure to download the update data; and
writing the update data in the corresponding specific field and displaying the updated field.

7. The method of claim 6, wherein the procedure is performed by timely triggering actions according to the settings of a timer.

8. The method of claim 6, wherein the procedure is performed by downloading the update data via a network.

9. The method of claim 6, wherein the procedure is performed at the client.
